(19) United States
(12) Patent Application Publication
(10) Pub. No.: US 2026/0260401 A1
(43) Pub. Date: Sep. 3, 2026

(54) Systems and Methods for Digitally Transforming Economic, Organizational and/or Industrial Content and/or Processes

(71) Applicant: Siemens Aktiengesellschaft, München (DE)

(72) Inventors: Raphaela Groten, Aachen (DE); Rebecca Johnson, München (DE)

(73) Assignee: Siemens Aktiengesellschaft, München (DE)

(21) Appl. No.: 18/841,846

(22) PCT Filed: Mar. 15, 2023
(86) PCT No.: PCT/EP2023/056600

§ 371 Date: Aug. 27, 2024

(30) Foreign Application Priority Data
Apr. 29, 2022 (DE) 10 2022 204 257.3

(51) Int. Cl. G06T 11/26; G06V 10/82; G06V 30/19; G10L 15/16

(52) U.S. Cl. CPC G06T 11/26; G06V 10/82; G06V 30/191; G10L 15/16

(57) ABSTRACT

Various embodiments of the teachings herein include systems for automatically transforming economic, organizational, and/or industrial content and/or processes capturable by natural language into a digital representation. An example includes: modules for capturing and/or recording user-specific data; processors to process captured data for forwarding to an AI and create digital representations in a recording language; an interface to a second processor associated with a neural network having an AI trained to carry out pattern analysis, pattern recognition, and/or pattern prediction on the basis of the processed user-specific recording data; and a second interface to transmit results from the data editing of the AI to the first processor to generate a digital representation made available to the user via a display module.

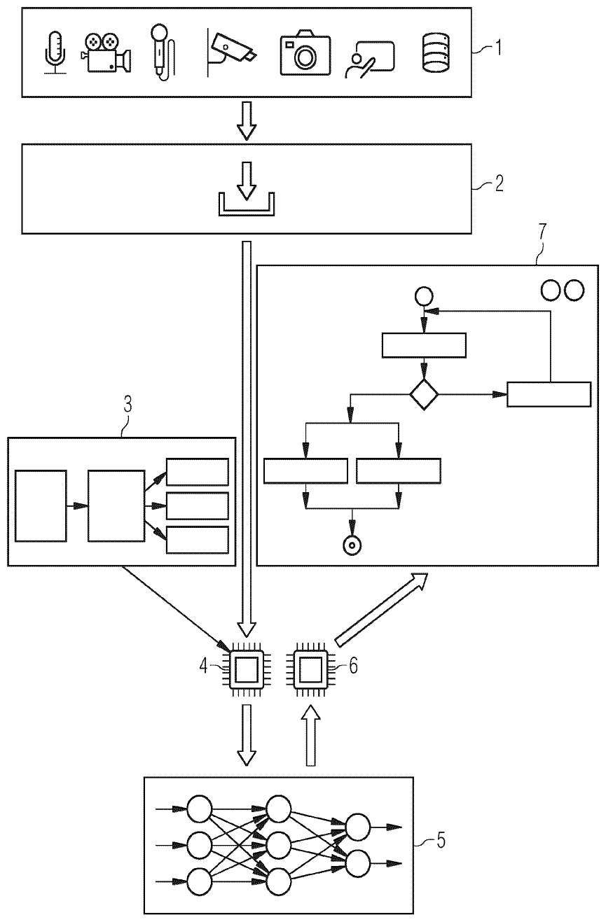

### CROSS-REFERENCE TO RELATED APPLICATIONS

This application is a U.S. National Stage Application of International Application No. PCT/EP2023/056600 filed May 15, 2023, which designates the United States of America, and claims priority to DE Application No. 10 2022 204 257.3 filed Apr. 29, 2022, the contents of which are hereby incorporated by reference in their entirety.

### TECHNICAL FIELD

The present disclosure relates to digital representation of real world or analog systems. Various embodiments of the teachings herein include systems and/or methods for digitally transforming economic, organizational and/or industrial content and/or processes into a digital representation such as a digital formulation and/or visualization.

### BACKGROUND

In the course of digitally transforming economic, organizational and/or industrial processes, there are already some tools “tools” which facilitate the translation of real content and/or use of gathered data into digital representations, i.e. abstract, in particular IT-enabled, formulations or visualizations. In particular, in this context procedures that are complex, for example because they proceed naturally, are translated into logical concepts and/or processes. These digitally processable concepts and/or processes are rendered in various languages, each with associated rules and syntax.

By way of example, there are digitally capturable formulations of workflows and/or process representations such as BPMN “Business Process Model and Notation”, UML activity diagrams, where UML stands for “Unified Modeling Language”, EPC, where EPC stands for “Event-driven Process Chain”, which transform complex procedures representable in natural language descriptions, for example, into abstract formulations which follow a logical and therefore digitally translatable concept.

Examples of visualizations in the field which represent the technically generally customary activities, relationships, temporal sequences and/or organizations in a digitally capturable manner are for example flowcharts, circuit diagrams, rules for the networking of the individual elements in £ manufacturing installations, representations of elementary actions and the connections thereof to supervisory and/or data flows. These visualizations are not only prevalent but also the basis for the transformation of processes that really take place into digitally capturable and editable data and data sets.

BPMN is nowadays the de facto standard for the description of business processes. BPMN is a modeling language and depicts activities in the form of a rounded rectangle for e.g. tasks or functions and an event in the form of a circle, such as “customer adviser promotes product to customers by providing samples”, for example. The sequence is symbolized by arrows and branching such as e.g. “order received”, on the one hand, and “30 days with no response to samples provided”, on the other hand, with a diamond. Flowcharts created in this way are familiar to every employee. In order to make content more precise, there is the option of supplementing the basic symbols with the aid of small icons. The form and fundamental meaning remain the same, however. This lowers the entry hurdle for the readers of the process diagrams and increases the acceptance primarily by specialist employees.

A UML diagram visualizes a system; by way of example, a UML diagram renders a representation of complex production sequences and/or manufacturing installations that is comparable to a circuit diagram, activities being integrable. A UML diagram thus replaces and accelerates the familiarization time for new production lines, gives instructions and also gives the employee the opportunity to comment.

An EPC is a graphical modeling language for visualizing sequential processes of a manufacturing installation or organization. In principle, work processes such as e. g. “filling the boiler”, “opening the valve”, “monitoring the steam pressure in the boiler” or else “issuing an offer” are visualized here by means of syntax rules. This concept based on the logic of the representation is intended to enable an unambiguous description of the processes underway. This is an essential element of the so-called Architecture of Integrated Information Systems (ARIS).

In order to optimize an existing digital representation of content and/or processes, sequences and/or relationships or in order to introduce new digital representations of processes, sequences and/or relationships, by means of interviews with users or performers of the visualizations, protocols and detailed workflows are created manually and then discussed for hours in laborious meetings with many participants. The results are then used to create new and/or optimized digital representations.

### SUMMARY

The teachings of the present disclosure may be used to reduce the outlay for the optimization of existing digital representations and/or introduction of new digital representations by providing an automated transformation of the real events, processes, sequences and relationships into digital ones. As an example, some embodiments include a system for automatically transforming economic, organizational and/or industrial content and/or processes capturable by natural language into a digital representation, comprising: one or more modules for capturing and/or recording user-specific data; one or more interfaces and/or memories of said modules with respect to at least; one first processor configured such that it processes captured data for forwarding to an AI “Artificial Intelligence” and can create digital representations in a recording language; and at least one interface from the at least one first processor to at least one second processor with at least one neural network with at least one AI, the at least one AI being trained such that it can carry out pattern analysis, pattern recognition and/or pattern prediction on the basis of the processed user-specific recording data; and at least one further interface for transmitting the results from the data editing of the AI to a first processor for generating at least one digital representation which as a proposal is made available to the user via a display module, such that the information from the modules for capturing and/or recording the user-specific data, by way of at least one digital representation generated in an automated manner, is usable as a proposal for a solution.

As another example, some embodiments include a method for transforming natural language content into a digital representation in an automated manner, comprising: generating user-specific data by way of corresponding modules; processing the user-specific data for feeding into at least one neural network with at least one AI; editing the processed user-specific data by means of the AI; and communicating the AI-developed solutions and/or questions on the basis of the user-specific data and any digital representation(s) present to a processor; and visualizing and/or outputting the AI-developed proposals of digital representations for/to the users.

As another example, some embodiments include a computer program product which can be loaded into the internal memory of a digital computer and comprises software code sections which carry out one or more of the methods described herein.

### BRIEF DESCRIPTION OF THE DRAWINGS

The teachings are explained in greater detail below with reference to the FIGURE showing a schematic diagram of an example system incorporating teachings of the present disclosure with arrows representing how the method proceeds by way of example.

### DETAILED DESCRIPTION

When translating and/or transforming economic, industrial and/or organizational processes and/or other content such as tasks, events, functions and/or sequences into digital representations such as formulation(s) and/or visualization(s), from totally different areas of life, recurring patterns occur which are able to be identified and possibly even predicted by means of a suitable artificial intelligence and an automated digital transformation at least of portions of the content and/or work processes is thus made possible. This primarily finds application in the introduction of new work processes and/or in the optimization of existing workflows. Digital representations such as digital formulations and/or visualizations are proposed by means of the invention during the introduction and/or optimization of the existing digital representation system by the AI. These proposals can then immediately be used as a basis for the further discussion and introduce solution approaches from different areas of business and/or areas of life which would possibly otherwise have been disregarded in this sector.

The pattern recognition of the AI makes it possible to compare the digital representation present with a lot of solution approaches present from all fields pertaining to economics and technology. By way of a processor and a display module, approximately at the same time as the user-specific data are recorded and captured, the AI makes available to the users one or more proposals for solving the problem/the problems raised in the user-specific data. The AI can thus practically “participate” in the discussion and spare the need for the discussion to take up valuable analysis time and/or time for the search for solutions that are already known. Reorganizations in companies can be carried out significantly more cost-effectively as a result.

Moreover, the quality of the solutions increases if, by way of the suitable modules, it is possible to take account of all user-specific data from different modules for recording and/or capture and/or from different sectors and branches of industry to-according to the analysis of the AI-experiences and/or solution approaches from similar cases concomitantly influence the discussion. For this purpose, the AI may be connected to cloud applications.

Using the teachings herein, a considerable acceleration of the transformation times can be achieved and the introduction of innovations and the optimization of existing digital representations such as workflows can be done more effectively. The result or the results of the pattern recognition and/or pattern analysis of the AI, composed of the training data of the AI and the data currently recorded with respect to the contemplated revision of an existing digital representation and/or new introduction of a further digital representation, is/are then used as the basis of a revision of the process. Results of the AI in the form of proposals for a digital representation can be presented in real time and repeatedly within a meeting.

The complexity of the coexistence and the cooperation is constantly increasing. In particular, the data gathered here are becoming ever more complex and unclear. There is therefore the need for tools which recognize similar patterns from many different areas in order that similar solution proposals for digital representations are made available more rapidly, in particular in real time and/or during an ongoing discussion concerning optimization and/or new introduction—for example of a workflow. The process recording of industrial and/or business processes, in particular, is such a complex procedure which translates a natural language description of—in part certainly also implicit—knowledge of the participating users into the abstract formulation—or digital representation—and visualization of workflows and process representations such as e.g. BPMN, UML, EPC.

As “module for capturing and/or recording user-specific data”, for example, the following devices are integrated in the system: microphone, camera, notes on whiteboards, comment fields, etc., which are usable as tools for capturing the user-specific suggestions for optimization, change, capture, new introduction of digital representations. For applications of the invention which encompass industrial installations, modules in the form of sensors, too, can supply user-specific data. In the case of optimizations, the digital representations present are processed in connection with the captured and recorded user-specific data by the AI.

As recording language of the digital representation, the language of the digital representation already available may be used, for example UML, BPML and/or EPC. The proposals provided by the system are then drawn up in the rules and/or patterns of the respective recording language. In this case, for example, here, acoustic data are captured by way of microphones and/or visual data are captured by way of video.

As display module, all conventional rendering devices of digital solutions are usable, for example display, smartphone, monitor, laptop, tablet, handheld, voice output, pop-up window, printer. A display module can render information in the form of a storable and/or stored digital representation and/or a variable digital representation.

A computer is a device which processes data by means of programmable computation specifications. A computer comprises at least one processor.

By means of the at least one processor, these user-specific data originally in analog form and/or originating from sensors are captured and converted into data for communication to the AI and further processing. In this case, various processing programs and/or analysis methods, such as “natural language processing”, in particular speech analysis, gesture recognition, can be used, such that the processed data in the AI are directly usable for the pattern assignment, pattern analysis or pattern recognition.

As used herein, a “processor” can be understood to mean a machine and/or an electronic circuit, for example. A processor can be, but is not limited to, a central processing unit (CPU), a microprocessor or a microcontroller, for example an application-specific integrated circuit or a digital signal processor, possibly in combination with a storage unit for storing program instructions, etc. A processor can for example also be an IC (integrated circuit), in particular an FPGA (field programmable gate array) or an ASIC (application-specific integrated circuit), or a DSP (digital signal processor) or a graphic processing unit (GPU).

Moreover, a processor can be understood to mean a virtualized processor, a virtual machine or a soft CPU. It can for example also be a programmable processor which is equipped with configuration steps for carrying out the stated method according to the invention or is configured with configuration steps in such a way that the programmable processor realizes the features of the methods described herein or of the modules, or of other aspects and/or partial aspects.

As used herein, a “module” can be understood to mean for example a device such as a microphone, a camera and/or a storage unit for storing acoustic and/or visual data. By way of example, the processor is specifically designed to execute the digital representation so that the AI executes functions to implement or realize pattern analysis, pattern recognition and/or pattern prediction and/or a step of the methods described herein. The respective modules can for example also be embodied as separate or independent modules. For this purpose, the corresponding modules can comprise further elements, for example. These elements are for example one or more interfaces (e.g. database interfaces, communication interfaces—e.g. network interface, WLAN interface) and/or an evaluation unit (e.g. a further processor) and/or a storage unit. By means of the interfaces, for example, data can be exchanged (e.g. received, communicated, transmitted or provided). By means of the evaluation unit, data can be compared, checked, processed, assigned or calculated for example in a computer-aided and/or automated manner. By means of the storage unit, data can be stored, retrieved or provided for example in a computer-aided and/or automated manner.

The modules generate user-specific data from the recordings of, for example, one or more microphone(s), camera(s), whiteboards, notes, etc. The digital, visual and/or acoustic data obtained in the process are processed for example by a program for face recognition, voice recognition, gesture recognition, pitch.

The term “automatic unit” or “automatic” or “automated” here denotes an independent execution, of one or more technical procedures according to a code, a defined plan and/or in relation to defined states. In this case, the range of automated sequences is as wide as the possibilities for the computer-aided processing of data per se. An AI is then fed these user-specific data and, if appropriate, an already existing digital representation so as to carry out pattern analysis, pattern recognition and/or pattern predictions and in that context to yield one or more proposals concerning a digital representation by means of at least one second processor—preferably in real time.

By virtue of the teachings of the present disclosure—for example in the optimization of an existing industrial process sequence—a combination of recordings from the different modules of persons, process-relevant objects, notes, whiteboard information, digital process data and/or databases optionally in combination with digital representations—to be revised—already present is used in order to create a new or an optimized digital process representation in an automated manner by means of AI.

For this purpose, for example, a combination of different feedback loops regarding the quality and completeness of the process recording of the recorded process is also offered to the user. The AI employed uses training data from various technical and/or economic fields, for example via direct access to cloud applications by the AI.

By means of AI, for example, recurring gestures and patterns, combinations, relationships can then be recognized in an automated manner and mutually compared in a targeted manner. They allow conclusions to be drawn about the emotional effect of a specific digital representation.

The term “cloud applications” denotes, in principle, programs which users can access primarily via the Internet. By way of example, these programs are installed on a server and not on the local processors.

The term “server” denotes a computer program and/or a device that quite generally provides functionalities for other programs and/or devices. A hardware server is a computer on which one or more “servers” run.

Unless indicated otherwise in the following description, the terms “to process”, “to carry out”, “to produce”, “computer-aided”, “to compute”, “to transmit”, “to generate” and the like preferably relate to actions and/or processes and/or processing steps which alter and/or produce data and/or convert data into other data, where the data can be represented or be available in particular as physical variables, for example as electrical pulses.

In particular, the expression “server” should be interpreted as broadly as possible to cover in particular all electronic devices having data processing properties. Servers can thus be for example personal computers, handheld computer systems, Pocket PC devices, mobile radio devices and other communication devices which can process data in a computer-aided manner, processors and other electronic devices for data processing.

As used herein, “computer-aided” can be understood to mean for example an implementation of the method in which, in particular, a server carries out at least one method step of the method using a processor. For example, services and platforms of third-party providers which can be accessed by businesses in the context of a multi-cloud or hybrid cloud architecture are usable by way of cloud applications. In this case, e.g. computer, storage, database, analysis, network and security services can be used.

The FIGURE shows right at the top a plurality of modules for capturing and/or recording user-specific data 1, such as data present in databases concerning the industrial process and/or data pertaining to the acoustic data such as are obtainable via a microphone. These are—in the order illustrated in the form of pictograms—fixed microphone, movable camera, movable microphone, handheld camera, whiteboard with user, and on the far right a database.

The data generated by the modules 1 are stored and saved in a corresponding data memory 2. The processor 4 can access the saved data by means of a suitable programming interface API.

In this case, from the data memory 2 and, if appropriate, a digital representation template 3, the processor 4 takes the input data present and processes them for forwarding to the AI; for example, the processor converts data of a relational database into data of a graph database. For example, the processor is configured such that it uses tools from the semantic web which are based on W3C standards. One example thereof is the W3C standard R2RML-RDB-RDF assignment language.

For example, the processor 4 is also configured such that it has one or more program(s) for processing natural language which convert for example stored acoustic data into machine-editable data—for example of a graph database—by means of “natural language processing”.

“Natural language processing” is understood to mean for example
optical character recognition, where written and/or printed text is converted into data,
voice recognition, where spoken words are converted into data,
machine translations
mood analysis etc.

Natural language processing is concerned, in principle, with the interactions between computers and human language, in which case, as stated, mood analyses can also be incorporated.

The machine-processable data generated in the processor 4 are then sent to the AI 5, which optionally—not shown here—has access to cloud applications. The AI 5 translates the information from for example the voice recordings during the actual process recording in a meeting and then translates this into workflows and/or activity diagrams, which the AI forwards to a processor 6, which uses them, while complying with the stipulations of the rules and patterns of the respective recording language, to visualize and/or display a proposal 7 for an optimization of an existing or a new digital representation.

In some embodiments, the system may assume the role of moderator in the meeting and for example for the AI 5 to raise queries to the users and/or to point out gaps in the workflow via corresponding output devices 7 and the processor 6. For example, a business analysis of the predefined digital representations of existing workflows can also be effected by way of the AI.

The teachings of the present disclosure for the first time can supply a meeting team with proposals for transforming economic, industrial and/or organizational content and/or processes in real time in an automated manner, owing to the system running by way of an AI. The system is thus able to follow a conversation between a number of persons. The engagement of a business analyst and/or a business consultant can be rendered superfluous by virtue of the fact that, by way of the AI 5 and optionally accessible cloud applications, the system compares the questions raised with comparable questions from other technical or economic sectors and/or, by way of pattern recognition for these, present solutions of the digital representation are made available to the meeting participants by the system.

What is claimed is:

1. A system for automatically transforming economic, organizational, and/or industrial content and/or processes capturable by natural language into a digital representation, the system comprising:
one or more modules for capturing and/or recording user-specific data;
a first processor to process captured data for forwarding;
a first interface from the first processor to a second processor associated with a neural network having an Artificial Intelligence (AI) trained to carry out pattern analysis, pattern recognition, and/or pattern prediction on the basis of the processed user-specific recording data; and
a second interface to transmit results from the second processor to the first processor generate a digital representation made available to the user via a display module.

2. The system as claimed in claim 1, wherein the first processor has a program for optical character recognition.

3. The system as claimed in claim 1, wherein the first processor has a program for voice recognition.

4. The system as claimed in claim 1, wherein the first processor has a program for mood analysis.

5. The system as claimed in any claim 1, wherein one of the one or more modules comprises: a microphone, a camera, and/or a whiteboard.

6. The system as claimed in claim 1, wherein the AI is connected to a cloud via a programming interface.

7. The system as claimed in claim 1, wherein the recording language for generating a digital representation as the result of the data editing by the AI is selected from the programming languages: BPMN, UML, and EPC.

8. The system as claimed in claim 1, wherein the user-specific data comprise one or more existing digital representations.

9. A method for transforming natural language content into a digital representation in an automated manner, the method comprising:
generating user-specific data with corresponding modules;
processing the user-specific data for feeding into a neural network having an Artificial Intelligence (AI);
editing the processed user-specific data with the AI;
communicating the AI-developed solutions and/or questions and any digital representations present to a processor;
displaying the AI-developed proposals of digital representations to the users.

10. The method as claimed in claim 9, carried out at the same time as capturing and/or recording the user-specific data.

11-12. (canceled)

13. The method as claimed in claim 9, wherein the AI has access to cloud applications.

14. The method as claimed in claim 19, wherein the AI raises queries and/or demonstrates gaps in the digital representation to the users by way of the display modules.

15. (canceled)
